(19) United States
(12) Patent Application Publication
(10) Pub. No.: US 2025/0382018 A1
(43) Pub. Date: Dec. 18, 2025

(54) METHODS, SYSTEMS, AND DEVICES FOR A TAILGATE DRAWER FOR A VEHICLE

(71) Applicant: Toyota Motor Engineering & Manufacturing North America, Inc., Plano, TX (US)

(72) Inventors: Paxton S. Williams, Milan, MI (US); Scott L. Frederick, Brighton, MI (US); Ryan C. Harris, Saline, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/743,495

(22) Filed: Jun. 14, 2024

(51) Int. Cl. B62D 33/02; B60L 50/60; B60R 25/01; E05B 81/04; E05B 81/56; E05B 83/00; E05F 15/60; E05F 15/73

(52) U.S. Cl. CPC B62D 33/0207; B60L 50/66; B60R 25/01; E05B 81/04; E05B 81/56; E05B 83/00; E05F 15/60; E05F 15/73; E05Y 2201/434; E05Y 2900/53

(57) ABSTRACT

Methods, systems, and devices for a tailgate drawer for a vehicle. The tailgate drawer may include a bed floor positioned along a first horizontal plane. The tailgate drawer may further include a battery positioned underneath the bed floor and lying along a second horizontal plane being parallel to the first horizontal plane. The battery may be configured to store and supply electrical energy. The tailgate drawer may further include a drawer lying along the second horizontal plane and positioned rearward of the battery with respect to the vehicle. The drawer may be configured to move between a closed position and an open position. The drawer may include a plurality of walls defining a storage compartment. The drawer may further include one or more electrical outlets electrically connected to the battery and coupled to one or more walls of the plurality of walls.

### BACKGROUND

### 1. Field

The present disclosure relates to methods, systems, and/or devices for a tailgate drawer for a vehicle.

### 2. Description of the Related Art

An electrified pickup truck (e.g., a battery electric vehicle (BEV) or a plug-in hybrid electric vehicle (PHEV)) may locate a battery pack in a front portion of a bed of the electrified pickup truck. This may improve battery capacity and range but worsens the utility of the electrified pickup truck. For example, the battery pack may result in the front portion of the bed being a raised shelf such that the bed is not level. This may make loading items (e.g., 4×8 foot boards) into the bed difficult. Alternatively, the battery pack may result in a floor of the bed being raised such that the bed is level, but also has a reduced storage area. Also, the battery pack in the front portion of the bed may provide excessive weight towards the front of the pickup truck.

Accordingly, it is desirable to provide methods, systems, and devices for a tailgate drawer for a vehicle.

### SUMMARY

In general, one aspect of the subject matter described in this disclosure may be embodied in a tailgate drawer for a vehicle. The tailgate drawer may include a bed floor positioned along a first horizontal plane. The tailgate drawer may further include a battery positioned underneath the bed floor and lying along a second horizontal plane being parallel to the first horizontal plane. The battery may be configured to store and supply electrical energy. The tailgate drawer may further include a drawer lying along the second horizontal plane and positioned rearward of the battery with respect to the vehicle. The drawer may be configured to move between a closed position and an open position. The drawer may include a plurality of walls defining a storage compartment. The drawer may further include one or more electrical outlets electrically connected to the battery and coupled to one or more walls of the plurality of walls.

In one aspect, the subject matter may be embodied in a tailgate drawer for a vehicle. The tailgate drawer may include a bed floor positioned along a first horizontal plane. The tailgate drawer may further include a drawer lying along a second horizontal plane parallel to the first horizontal plane. The drawer may be configured to move between a first closed position and a first open position. The drawer may be positioned underneath the bed floor when in the first closed position. The drawer may have a plurality of walls defining a storage compartment. The drawer may further have a lid. The lid may be configured to move between a second closed position and a second open position. The lid may have webbing configured to provide a plurality of attachment points to secure one or more tools to the lid.

### BRIEF DESCRIPTION OF THE DRAWINGS

Other systems, methods, features, and advantages of the present disclosure will be apparent to one skilled in the art upon examination of the following figures and detailed description. Component parts shown in the drawings are not necessarily to scale and may be exaggerated to better illustrate the important features of the present disclosure. In the drawings, like reference numerals designate like parts throughout the different views.

FIG. 1 is a schematic of an example vehicle with which an example tailgate drawer may be implemented according to an aspect of the disclosure.

FIG. 2 is a schematic perspective view of a rear portion of an example vehicle including the tailgate drawer of FIG. 1 and illustrating a closed position of the tailgate drawer according to an aspect of the disclosure.

FIG. 3 is a schematic perspective view of a rear portion of an example vehicle including the tailgate drawer of FIG. 1 and illustrating an open position of the tailgate drawer according to an aspect of the disclosure.

FIG. 4 is a schematic perspective view of a rear portion of an example vehicle including the tailgate drawer of FIG. 1 and illustrating one or more doors of the tailgate drawer according to an aspect of the disclosure.

FIG. 5 is a schematic left side view of a rear portion of an example vehicle including the tailgate drawer of FIG. 1 and illustrating movement of the tailgate drawer according to an aspect of the disclosure.

FIG. 6 is a schematic perspective view of a rear portion of an example vehicle including the tailgate drawer of FIG. 1 and illustrating a power panel of the tailgate drawer according to an aspect of the disclosure.

FIG. 7 and FIG. 8 are schematic perspective views of a rear portion of an example vehicle including the tailgate drawer of FIG. 1 and illustrating a lid of the tailgate drawer according to aspects of the disclosure.

### DETAILED DESCRIPTION

Disclosed herein are methods, systems, devices, and/or vehicles for implementing a tailgate drawer for a vehicle. Particular embodiments of the subject matter described in this disclosure may be implemented to realize one or more of the following advantages. The tailgate drawer may increase a storage capacity of the vehicle by holding one or more objects (e.g., electric and/or nonelectric tools) in a drawer located under a bed floor of the vehicle. The tailgate drawer may be positioned at a rear portion of a bed of the vehicle and a vehicle battery may be positioned at a front portion of the bed such that the tailgate drawer utilizes space adjacent to the vehicle battery. Thus, instead of the vehicle battery forming a shelf at the front portion of the bed, the vehicle battery and the tailgate drawer form a level bed floor which may improve the ease of loading and unloading items from the bed of the vehicle.

Moreover, the tailgate drawer may extend out from or near a tailgate of the vehicle such that a user may access a storage compartment of the tailgate drawer. The tailgate drawer may be manually or electronically controlled and actuated to open and close. When in a closed position, an exterior panel of the tailgate drawer may integrate into exterior body panels of the vehicle such that the tailgate drawer is flush with and/or follows body lines of the exterior body panels of the vehicle. In addition, the storage compartment of the tailgate drawer may be accessible via one or more doors in the bed floor of the vehicle.

Moreover, the tailgate drawer may be connected to the vehicle battery such that a user may connect and power and/or charge various tools via a power panel of the tailgate drawer. The tailgate drawer may power and/or charge various tools requiring high voltage (e.g., 110-120 volts and/or 220-240 volts) and/or high wattage (e.g., 1000-2000 watts or more).

Moreover, the tailgate drawer may include one or more motors and/or one or more sensors to automatically open or close the tailgate drawer in response to receiving a signal from a key fob and/or a mobile device and/or in response to detecting a user waving their hand or foot near and/or under the tailgate drawer.

Moreover, the tailgate drawer may include a lid having webbing and/or attachment points to secure and organize various objects and tools.

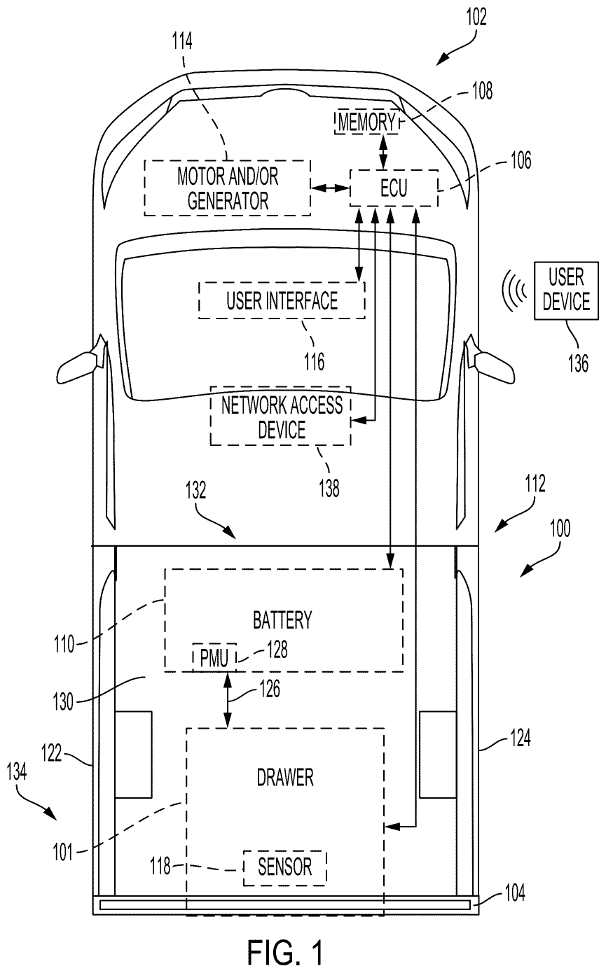

FIG. 1 illustrates an example vehicle 102 in which an example tailgate drawer 100 (also may be referred to as a split tailgate storage system 100) may be implemented. The tailgate drawer 100 may be retrofitted, coupled to, include, or be included within the vehicle 102 or separate from the vehicle 102. The vehicle 102 may be a conveyance capable of transporting a person, an object, or a permanently or temporarily affixed apparatus. The vehicle 102 may be a self-propelled wheeled conveyance, such as a car, a sports utility vehicle, a truck, a bus, a van or other motor, battery or fuel cell driven vehicle. For example, the vehicle 102 may be an electric vehicle, a hybrid vehicle, a hydrogen fuel cell vehicle, a plug-in hybrid vehicle or any other type of vehicle that has a fuel cell stack, a motor, an engine, and/or a generator. Other examples of vehicles include bicycles, trains, planes, or boats, and any other form of conveyance that is capable of transportation. The vehicle 102 may be semi-autonomous or autonomous. That is, the vehicle 102 may be self-maneuvering and navigate without human input. An autonomous vehicle may have and use one or more sensors and/or a navigation unit to drive autonomously.

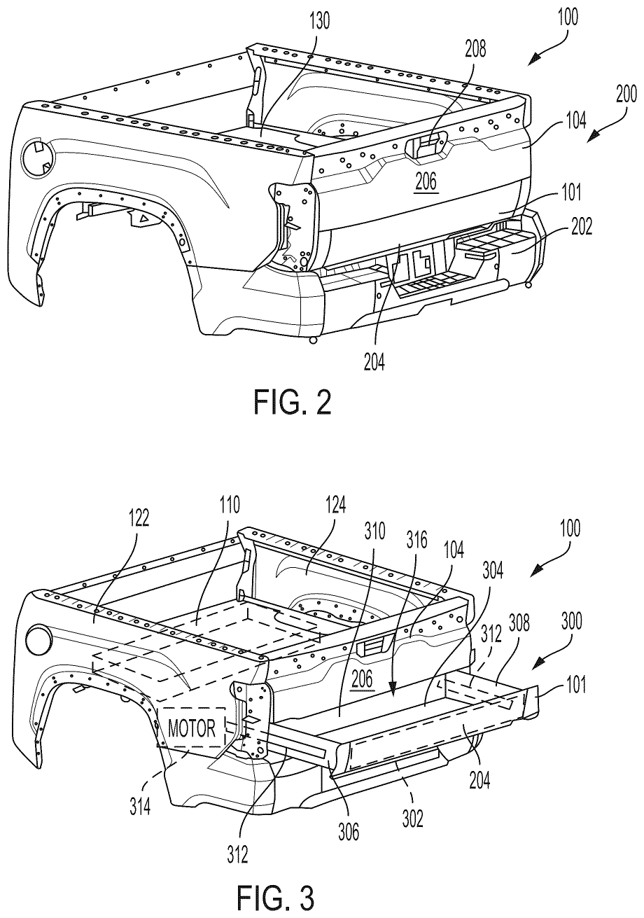

The vehicle 102 and/or the tailgate drawer 100 may further include a tailgate 104, a bed (or truck bed or trunk) 112, and/or a rear bumper 202 (not yet shown, marked in FIG. 2). The tailgate 104 may be positioned at or near a rear end of the vehicle 102 and/or a rear portion 134 of the bed 112. The tailgate 104 may be coupled to the rear end of the vehicle 102, the rear portion 134 of the bed 112, and/or the rear bumper 202. The tailgate 104 may be configured to open and close and may have an open state and a closed state. The tailgate 104 may include an outer (or exterior) panel 206 (not yet shown, marked in FIG. 2). The outer panel 206 may be an outer body panel of the vehicle 102 and may form a portion of an exterior surface of the vehicle 102. The bed 112 may have a front portion 132 and the rear portion 134 opposite of the front portion 132. The bed 112 may have a bed floor (or trunk floor or deck floor) 130 and a plurality of bed sides (or rear quarter panels) including a left bed side 122 and a right bed side 124. The bed floor 130 may define and/or be positioned along a first horizontal plane 502 (not yet shown, marked in FIG. 5). The bed floor 130 may be positioned forward of the tailgate 104 with respect to the vehicle 102. The bed floor 130 may be raised to accommodate a battery 110 and/or the tailgate drawer 100.

The vehicle 102 and/or the tailgate drawer 100 may further include a motor and/or generator 114 and/or the battery 110. The motor and/or generator 114 may be located within an engine bay of the vehicle 102. In examples, the motor and/or generator 114 may be located at and/or adjacent to two or more axles of the vehicle 102 such that the vehicle 102 includes a plurality of motors and/or generators. The motor and/or generator 114 may be an internal combustion engine (ICE). In this regard, the motor and/or generator 114 may combust an air and fuel mixture to provide power to the vehicle 102 and/or components of the vehicle 102 and/or the tailgate drawer 100. Accordingly, the motor and/or generator 114 can cause the vehicle 102 to accelerate, decelerate, or maintain a desired velocity. It should be understood that the motor and/or generator 114 may include combinations of an ICE and an electric motor, such as for hybrid vehicle applications for example. In examples, the motor and/or generator 114 may be an electric motor. In this regard, the motor and/or generator 114 may be an electric motor and an electric generator that converts electrical energy into mechanical power, such as torque, and converts mechanical power into electrical energy. The motor and/or generator 114 may be electrically connected to the battery 110. The motor and/or generator 114 may convert energy from the battery 110 into mechanical power, and may provide energy back to the battery 110, for example, via regenerative braking.

The battery 110 may be retrofitted, coupled to, include or be included within the vehicle 102. The battery 110 may be electrically connected to the motor and/or generator 114 and/or other components of the vehicle 102 and/or the tailgate drawer 100. The battery 110 may be located at or near the front portion 132 of the bed 112 and underneath the bed floor 130 (as shown in FIG. 5). The battery 110 may be positioned along a second horizontal plane 504 (not yet shown, marked in FIG. 5) with the second horizontal plane 504 being parallel to the first horizontal plane 502. The battery 110 may store chemical energy for later conversion to electrical energy. The battery 110 may provide the electrical energy to and/or receive electrical energy from the motor and/or generator 114 and/or other components of the vehicle 102. The battery 110 may provide electrical energy to the tailgate drawer 100. The battery 110 may be a battery pack that includes one or more battery modules, a cooling system, and/or a power management system (BMS). The one or more battery modules may each include one or more cells. The one or more cells may be cylindrical cells, prismatic cells, and/or pouch cells (in examples, other types of cells may be used). A chemistry of the one or more cells may be lithium ion (Li-Ion), nickel manganese cobalt (NMC), nickel metal hydride (Ni-MH), lithium sulfur (Li—S), and/or lead-acid (in examples, other chemistries may be used).

In examples, the vehicle 102 and/or the tailgate drawer 100 may further include one or more sensors 118, an electronic control unit (ECU) 106, a memory 108, a user interface 116, and/or a network access device 138. The one or more sensors 118 may be located on or within the vehicle 102. For example, the one or more sensors 118 may be coupled to the tailgate 104 and/or the rear bumper 202. The one or more sensors 118 may be and/or include one or more cameras, one or more sonar sensors, one or more lidar sensors, and/or one or more radar sensors. The one or more sensors 118 may be configured to detect movement near and/or underneath the vehicle 102, a drawer 101, the tailgate 104, and/or the tailgate drawer 100 (e.g., 0-3 feet in front of and/or underneath the vehicle 102, the drawer 101, the tailgate 104, and/or the tailgate drawer 100). For example, the one or more sensors 118 may detect when a user (e.g., a driver and/or passenger of the vehicle 102) approaches and/or waves a hand and/or a foot of the user near and/or underneath the vehicle 102, the drawer 101, the tailgate 104, and/or the tailgate drawer 100.

The ECU 106 may be implemented as a single ECU or in multiple ECUs. The ECU 106 may be electrically connected to some or all of the components of the vehicle 102 and/or the tailgate drawer 100. The ECU 106 may be electrically connected to the motor and/or generator 114, the battery 110, the one or more sensors 118, the memory 108, the user interface 116, and/or the network access device 138. The ECU 106 may include one or more processors (or controllers) specifically designed for controlling operations of the vehicle 102, such as accelerating, braking, lighting, etc.

The memory 108 may store instructions to execute on the ECU 106 and may include one or more of a random access memory (RAM) or other volatile or non-volatile memory. The memory 108 may be a non-transitory memory or a data storage device, such as a hard disk drive, a solid-state disk drive, a hybrid disk drive, or other appropriate data storage, and may further store machine-readable instructions, which may be loaded and executed by the ECU 106. The memory 108 may store vehicle parameters (e.g., vehicle weight, transmission gear information, etc.).

The user interface 116 may be located within a cabin of the vehicle 102 and/or may be coupled to a dashboard of the vehicle 102. The user interface 116 may provide an interface to the user of the vehicle 102 to interact with and/or receive output from the ECU 106. The user interface 116 may have a user interface element, such as a screen and/or a touchscreen with a button, a switch, a microphone, a speaker, a gesture monitoring sensor, a knob, a graphical user interface (GUI), and/or other input/output devices electrically connected to the ECU 106 to provide input and/or output of information (or data) to and/or from the ECU 106.

The network access device 138 may be electrically connected to the ECU 106 and may include a communication port or channel, such as one or more of a Wi-Fi unit, a Bluetooth® unit, a Radio Frequency Identification (RFID) tag or reader, a DSRC unit, and/or a cellular network unit for accessing a network 140 (e.g., CDMA, GSM, 3G, 4G, 5G, etc.). The network access device 138 may transmit data to and receive data from devices and systems not directly connected to the vehicle 102. For example, the ECU 106 may communicate with a user device 136 (e.g., a key fob of the vehicle 102 and/or a mobile device of the user such as a phone) via the network access device 138.

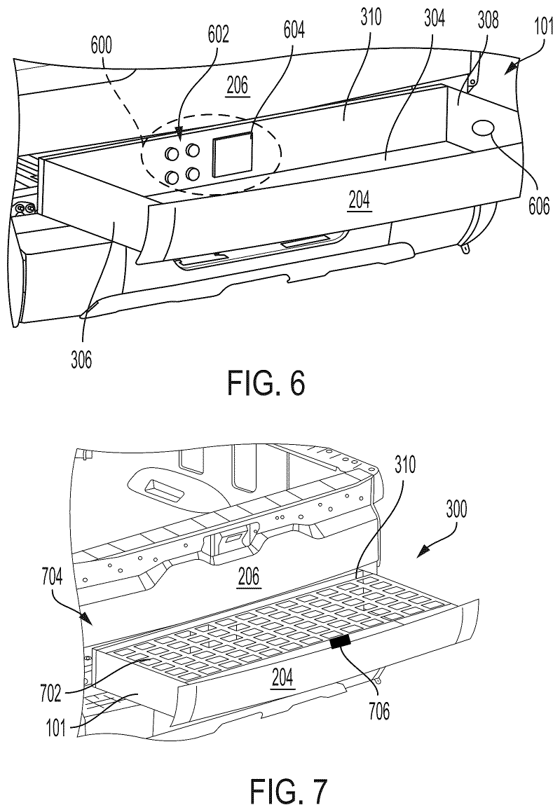

FIG. 2 and FIG. 3 each illustrate rear perspective views of an example vehicle 102 including the tailgate drawer 100 of FIG. 1. Referencing FIG. 2 and FIG. 3 with continuing reference to FIG. 1, the tailgate drawer 100 may include the drawer 101. The drawer 101 may be movably coupled to the left bed side 122, the right bed side 124, the tailgate 104, the rear bumper 202, and/or the rear end of the vehicle 102. The drawer 101 may have a closed position (or state) 200 (as shown by FIG. 2) and an open position (or state) 300 (as shown by FIG. 3). The drawer 101 may be configured to move (or slide along side rails) between the closed position 200 and the open position 300 (as more clearly illustrated by FIGS. 5 and 6). The drawer 101 may move rearward with respect to the vehicle 102 and extend beyond the outer panel 206 when moving toward the open position 300.

The drawer 101 may be positioned underneath the bed floor 130 (as more clearly illustrated by FIG. 5) when in the closed position 200. The drawer 101 may be positioned along the second horizontal plane 504 (marked in FIG. 5). In examples, the drawer 101 may be positioned between the rear bumper 202 and the bed floor 130 and/or the tailgate 104. The drawer 101 may be adjacent to and/or rearward of the battery 110 with respect to the vehicle 102. In examples, the drawer 101 may be at least partially integrated into the rear bumper 202.

The drawer 101 may be configured (or sized) to store and/or hold one or more objects (e.g., tools, a spare tire, etc.). The drawer 101 may be a substantially rectangular box having a plurality of walls (or sides) defining a storage compartment 316. The plurality of walls may include a rear wall 302, a floor (or bottom) 304, a left wall (or side) 306, a right wall (or side) 308, and/or a front wall (or side) 310. In examples, the drawer 101 may include one or more drain holes in the rear wall 302, the floor 304, the left wall 306, the right wall 308, and/or the front wall 310 to enable drainage of any water or other liquid within the drawer 101. The left wall 306 and the right wall 308 may define a width of the drawer 101 and/or the storage compartment 316. The storage compartment 316 may be located between the left bed side 122 and the right bed side 124 and may be underneath the bed floor 130 when the drawer 101 is in the closed position 200. The storage compartment 316 may be accessible (e.g., to place tools into and/or take tools out of the storage compartment 316) when the drawer 101 is in the open position 300. In examples, the storage compartment 316 may be inaccessible and/or enclosed when the drawer 101 is in the closed position 200.

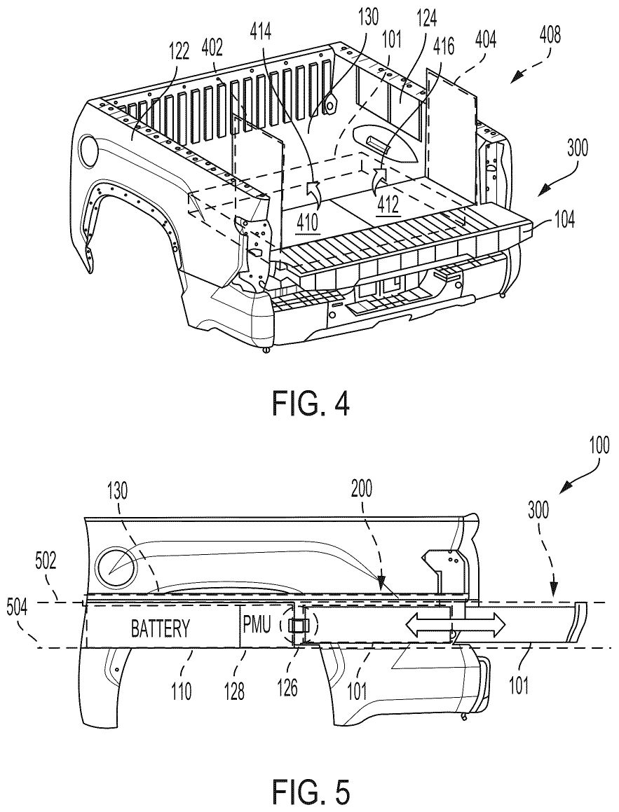

Referring briefly to FIG. 4 with continuing reference to FIG. 2 and FIG. 3, in examples the tailgate drawer 100 may further include one or more doors (or hatches) including a left (or first) door 402 and a right (or second) door 404 (in examples the tailgate drawer 100 may include one door or more than two doors). The one or more doors 402 and 404 may be located and/or movably coupled (e.g., via one or more hinges) to the bed floor 130. The one or more doors 402 and 404 may be configured to enable access to the storage compartment 316 when the drawer 101 is in the closed position 200. The one or more doors 402 and 404 may have a closed position (or state) wherein an outer surface 410 of the left door 402 and an outer surface 412 of the right door 404 form portions of the bed floor 130 (e.g., the one or more doors 402 and 404 may be positioned along the first horizontal plane 502 (marked in FIG. 5)). In addition, the one or more doors 402 and 404 may have an open position (or state) 408 wherein the left door 402 opens in an upward direction 414 away from the bed floor 130 and toward the left bed side 122 and the right door 404 opens in an upward direction 416 away from the bed floor 130 and toward the right bed side 124. In the open position 408, the user may access the storage compartment 316 of the drawer 101 while the drawer 101 is in the closed position 200.

Returning to FIG. 2 and FIG. 3 with continuing reference to FIG. 1, the tailgate drawer 100 may further include an exterior panel 204. The exterior panel 204 may be coupled to and/or form the rear wall 302 of the drawer 101. The exterior panel 204 may be another body panel of the vehicle 102 and may form another portion of the exterior surface of the vehicle 102. The exterior panel 204 may be configured to integrate with the outer panel 206 of the tailgate 104 and/or with the rear bumper 202 such that the exterior panel 204 is flush with the outer panel 206 and/or with other body panels of the vehicle 102 when the drawer 101 is in the closed position 200. The exterior panel 204 may have a width that is greater than the width of the storage compartment 316 to better integrate the drawer 101 into the vehicle 102 (e.g., by having the exterior panel 204 integrate and follow curves and/or body lines of the vehicle 102 and/or the tailgate 104 such that the exterior panel 204 appears to be a part of the tailgate 104 and/or the tailgate 104 appears to be a split tailgate). In examples, the width of the exterior panel 204 may be substantially the same as the width of the storage compartment 316.

The tailgate drawer 100 may further include one or more rails 312. The one or more rails 312 may movably couple the drawer 101 to the vehicle 102. The one or more rails 312 may be coupled to the left wall 306, the right wall 308, the floor 304, the left bed side 122, the right bed side 124, and/or the rear end of the vehicle 102. The one or more rails 312 may be configured to guide the drawer 101 between the closed position 200 and the open position 300 (e.g., when the user pulls or pushes the drawer 101).

In examples, the one or more rails 312 and/or the drawer 101 may be configured such that the drawer 101 is removable from the vehicle 102. This may enable the user to utilize the drawer 101 as a storage tub and/or to swap out the drawer 101 for other drawers. For example, the tailgate drawer 100 may be a system that includes a plurality of different drawers. The plurality of drawers may include, for example, the drawer 101, a kitchen unit drawer (e.g., having one or more burners), a toolbox drawer (e.g., having one or more sections for various tools), and/or a refrigerator drawer (e.g., having an integrated refrigerator system).

In examples, the tailgate drawer 100 may further include one or more motors (or actuators) 314. The one or more motors 314 may be coupled to the one or more rails 312 and/or the drawer 101. The one or more motors 314 may be electrically connected to the battery 110 and/or the ECU 106. The one or more motors 314 may be located at or near the rear portion 134 of the bed 112. The one or more motors 314 may be electric and/or pneumatic motors. The one or more motors 314 may be configured to automatically move the drawer 101 between the closed position 200 and the open position 300 when activated (e.g., via the ECU 106). For example, the user may use the user device 136 to send an open signal or a close signal to the vehicle 102. The ECU 106 may receive, via the network access device 138, the open signal or the close signal from the user device 136. The ECU 106 may control the one or more motors 314 to automatically open or close the drawer 101 based on the received open signal or the received close signal.

In examples, the one or more sensors 118 may detect the user waving a hand or a foot of the user near and/or underneath the tailgate 104, the tailgate drawer 100, the drawer 101, and/or the vehicle 102. The one or more sensors 118 may send an indication to the ECU 106 in response to detecting the user waving the hand or the foot of the user near and/or underneath the tailgate 104, the tailgate drawer 100, the drawer 101, and/or the vehicle 102. The ECU 106 may control the one or more motors 314 to automatically open or close the drawer 101 based on receiving the indication from the one or more sensors 118.

In examples, the user may use the user interface 116 and/or other buttons or switches coupled to the tailgate drawer 100, the vehicle 102, and/or the tailgate 104 to activate the one or more motors 314 to automatically open or close the drawer 101.

In examples, the tailgate drawer 100 may include a drawer lock 208. The drawer lock 208 may be coupled to the tailgate 104, the outer panel 206, the drawer 101, and/or the exterior panel 204. The drawer lock 208 may be configured to lock the drawer 101 in the closed position 200 to secure the contents of the storage compartment 316. The drawer lock 208 may be and/or include a manual lock that is configured to be locked and unlocked with a physical key of the vehicle 102. In examples, the drawer lock 208 may be and/or include an electric lock that is configured to be wirelessly locked and unlocked via the user device 136. For example, the user may use the user device 136 to send a lock signal or an unlock signal to the vehicle 102. The ECU 106 may receive, via the network access device 138, the lock signal or the unlock signal from the user device 136. The ECU 106 may control the drawer lock 208 to lock or unlock the drawer 101 based on the received lock signal or the received unlock signal (in examples, the ECU 106 may also control the one or more motors 314 to open or close the drawer 101 based on the received lock signal or the received unlock signal). The drawer lock 208 may be a tailgate lock for the tailgate 104 such that the tailgate 104 and the drawer 101 are both locked or unlocked via the same lock. In examples, the drawer lock 208 may be separate from the tailgate lock such that the drawer 101 may be locked or unlocked independently from the tailgate 104.

FIG. 5 illustrates a left side view of the rear of the example vehicle 102. FIG. 6 illustrates the drawer 101 in the open position 300. Referencing FIG. 5 and FIG. 6 with continuing reference to FIGS. 1-4, the tailgate drawer 100 and/or the vehicle 102 may further include a power management unit (PMU) 128, an electrical tether (or cable) 126, a power panel 600, and/or one or more lights 606. The PMU 128 may be coupled to and/or electrically connected to the battery 110, the one or more motors 314, and/or the power panel 600. The PMU 128 may be and/or include an inverter. The PMU 128 may regulate and/or provide electrical energy (received from the battery 110) to one or more components of the vehicle 102 and/or the tailgate drawer 100. For example, the PMU 128 may be electrically connected to the power panel 600 (e.g., via the electrical tether 126) and may be configured to regulate and/or provide electrical energy to the power panel 600 at one or more voltages. In examples, the PMU 128 may provide a plurality of voltages to the power panel 600 (e.g., from 5 volts to 20 volts and/or from 110 volts to 240 volts).

The power panel 600 may be coupled to the drawer 101. For example, the power panel 600 may be coupled to the rear wall 302, the left wall 306, the right wall 308, the floor 304, and/or the front wall 310. The power panel 600 may include one or more electrical outlets (or electrical connectors) 602 configured to receive various plugs or electrical connectors of one or more tools and/or electrical devices and provide electrical energy to the one or more tools and/or the electrical devices (e.g., a portable pump, a lamp, a portable heater, an electric stove, a table saw, a drill, a tool battery charger, a mobile phone charger, a laptop charger, etc.). The power panel 600 may be configured to supply electrical energy when the vehicle 102 is powered on and/or when the vehicle 102 is powered off. The one or more electrical outlets 602 may include one or more two and/or three prong outlets and/or one or more USB-A and/or USB-C ports (in examples, the one or more electrical outlets 602 may include other types of outlets and/or connectors).

The power panel 600 may further include a control panel 604. The control panel 604 may include one or more screens configured to display information such as a voltage output and/or a current state of charge of the battery 110 and/or a charge status of one or more tools or electrical devices that are connected to the one or more electrical outlets 602 (in examples, in addition to or instead of the control panel 604, the user interface 116 may display the voltage output and/or the current state of charge of the battery 110 and/or the charge status of the one or more tools or electrical devices that are connected to the one or more electrical outlets 602). The control panel 604 may include one or more switches, dials, buttons, and/or touch screens configured to switch each of the one or more electrical outlets 602 on or off and/or to control a voltage output of each of the one or more electrical outlets 602. In examples, a voltage output of a given electrical outlet of the one or more electrical outlets 602 may be based on a type or configuration of the given electrical outlet (e.g., USB-A, USB-C, two prong, etc.).

In examples, the power panel 600 may be directly connected to the battery 110 via the electrical tether 126 and/or the PMU 128. Because the power panel 600 is electrically connected to the battery 110 directly, the power panel 600 may be capable of high voltage output such as 110 volts, 120 volts, 220 volts, or 240 volts (in examples the power panel 600 may be capable of outputting other voltages less than 110 volts or greater than 240 volts) and/or may be capable of outputting numerous voltages such as from 5 volts to 110 volts, 5 volts to 240 volts, and/or 110 volts to 240 volts (in examples the power panel 600 may be capable of numerous voltage outputs anywhere from below 5 volts to above 240 volts). Moreover, the power panel 600 may be able to power a plurality of tools and/or electrical devices simultaneously by having a wattage rating of between 400 watts and 2000 watts (in examples the power panel 600 may have a wattage rating of less than 400 watts or more than 2000 watts).

The one or more lights 606 may be coupled to the rear wall 302, the left wall 306, the right wall 308, the floor 304, and/or the front wall 310. The one or more lights 606 may receive electrical energy from the battery 110 via the electrical tether 126 and/or the PMU 128. In examples, the user may control the one or more lights 606 via the control panel 604 of the power panel 600 and/or the user interface 116 (e.g., activating or deactivating the one or more lights 606 and/or changing a brightness level of the one or more lights 606). The one or more lights 606 may include one or more storage compartment 316 lights that may generate light to illuminate the storage compartment 316 when the drawer 101 is in the open position 300 and/or when the drawer 101 is in the closed position 200 and at least one of the one or more doors 402 and 404 are in the open position 408. In examples, the one or more lights 606 may include one or more puddle lights that may generate light toward the ground below the vehicle 102 when the drawer 101 is in the open position 300.

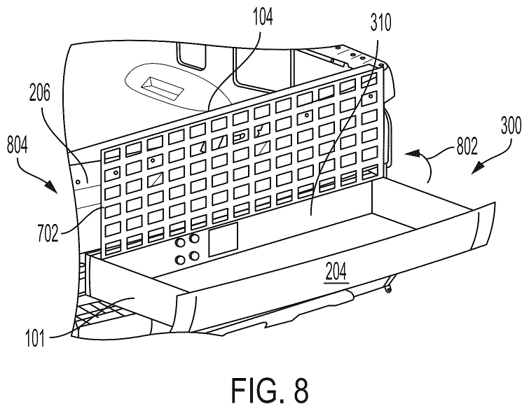

FIG. 7 and FIG. 8 each illustrate the drawer 101 in the open position 300. Referencing FIG. 7 and FIG. 8 with continuing reference to FIG. 1 and FIG. 3, the tailgate drawer 100 may further include a lid (or top panel) 702. The lid 702 may be movably coupled (e.g., via one or more hinges or straps) to the drawer 101. For example, the lid 702 may be movably coupled to the floor 304, the left wall 306, the right wall 308, and/or the front wall 310 of the drawer 101. The lid 702 may have a closed position 704 (as shown by FIG. 7) and an open position 804 (as shown by FIG. 8). The lid 702 may be configured to move between the closed position 704 and the open position 804. The lid 702 may secure the contents of the storage compartment 316 and/or enclose (or cover) the storage compartment 316 when in the closed position 704. The lid 702 may be configured to open to the open position 804 in an upward direction 802 toward the tailgate 104. In the open position 804, the user may be able to access the storage compartment 316 of the drawer 101. Moreover, the lid 702 may be configured to protect the outer panel 206 from scratches or damage when in the open position 804.

In examples, the lid 702 may be configured to automatically open (e.g., via electric or pneumatic actuators such as the one or more motors 314) when the drawer 101 moves to the open position 300. In examples, the lid 702 may be and/or include webbing (e.g., MOLLE webbing) or may be a solid hard top cover. The webbing may provide a plurality of attachment points to enable the user to attach various tools and/or objects to the lid 702. Thus, the lid 702 may function as a tool rack to secure and/or organize tools. The lid 702, when in the closed position 704, may be flush (lie along the same plane) with a top portion or surface of the bed floor 130.

In examples, the drawer 101 may include a lid lock 706 configured to lock the lid 702 in the closed position 704 to secure the contents of the storage compartment 316. The lid lock 706 may be and/or include a manual lock that is configured to be locked and unlocked with a physical key of the vehicle 102. In examples the lid lock 706 may be and/or include an electric lock that is configured to be locked and unlocked via the user device 136 (in a similar or same manner as, for example, the drawer lock 208).

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A tailgate drawer for a vehicle, comprising:
a bed floor positioned along a first horizontal plane;
a battery positioned underneath the bed floor and lying along a second horizontal plane being parallel to the first horizontal plane, the battery being configured to store and supply electrical energy; and
a drawer lying along the second horizontal plane and positioned rearward of the battery with respect to the vehicle, the drawer being configured to move between a first closed position and a first open position and having:
a plurality of walls defining a storage compartment, and
one or more electrical outlets electrically connected to the battery and coupled to one or more walls of the plurality of walls.

2. The tailgate drawer of claim 1, further comprising:
a tailgate positioned at a rear end of the vehicle and having an outer panel forming a portion of an exterior surface of the vehicle; and
an exterior panel coupled to the drawer and configured to be flush with the outer panel of the tailgate when the drawer is in the first closed position.

3. The tailgate drawer of claim 1, further comprising:
a lid movably coupled to the drawer and having:
webbing configured to secure one or more tools to the lid, and
a second closed position and a second open position, the lid being configured to enclose the storage compartment when the lid is in the second closed position.

4. The tailgate drawer of claim 1, further comprising:
one or more lights coupled to at least one wall of the plurality of walls and configured to illuminate the storage compartment when the drawer is in the first open position.

5. The tailgate drawer of claim 1, further comprising:
one or more doors moveably coupled to the bed floor and configured to move between a second closed position and a second open position; and
wherein:
the one or more doors are positioned along the first horizontal plane when the one or more doors are in the second closed position, and
the one or more doors enable access to the storage compartment when the one or more doors are in the second open position.

6. The tailgate drawer of claim 1, further comprising:
a power management unit electrically connected to the battery and the one or more electrical outlets and having an inverter, the power management unit being configured to provide a plurality of voltages to the one or more electrical outlets; and
wherein the battery is further configured to supply electrical energy to one or more electric motors of the vehicle.

7. The tailgate drawer of claim 1, further comprising:
one or more actuators coupled to the drawer and configured to move the drawer between the first closed position and the first open position; and
an electronic control unit (ECU) electrically connected to the one or more actuators and configured to control the one or more actuators to move the drawer between the first closed position and the first open position.

8. The tailgate drawer of claim 7, further comprising:
one or more sensors electrically connected to the ECU and configured to detect a user waving a hand or a foot of the user near or underneath the drawer or the vehicle; and
wherein the ECU is further configured to:
receive an indication when the one or more sensors detect the user waving the hand or the foot of the user near or underneath the drawer or the vehicle, and
control the one or more actuators to move the drawer to the first open position in response to receiving the indication.

9. The tailgate drawer of claim 1, further comprising:
a lock configured to lock the drawer in the first closed position and unlock the drawer such that the drawer may move to the first open position; and
an electronic control unit (ECU) electrically connected to the lock and configured to control the lock to:
lock the drawer in response to receiving a lock signal from a key fob of the vehicle or a mobile device in communication with the ECU, and
unlock the drawer in response to receiving an unlock signal from the key fob of the vehicle or the mobile device.

10. The tailgate drawer of claim 1, further comprising:
one or more rails configured to movably couple the drawer to the vehicle; and
wherein the drawer is configured to be removable from the vehicle.

11. A tailgate drawer for a vehicle, comprising:
a bed floor positioned along a first horizontal plane; and
a drawer lying along a second horizontal plane parallel to the first horizontal plane, the drawer being configured to move between a first closed position and a first open position, the drawer being positioned underneath the bed floor when in the first closed position, the drawer having:
a plurality of walls defining a storage compartment, and
a lid configured to move between a second closed position and a second open position and having webbing configured to provide a plurality of attachment points to secure one or more tools to the lid.

12. The tailgate drawer of claim 11, further comprising:
a tailgate positioned at a rear end of the vehicle and having an outer panel forming a portion of an exterior surface of the vehicle; and
an exterior panel coupled to the drawer and configured to be flush with the outer panel of the tailgate when the drawer is in the first closed position.

13. The tailgate drawer of claim 11, further comprising:
a battery positioned underneath the bed floor and lying along the second horizontal plane, the battery being configured to store and supply electrical energy; and
one or more electrical outlets electrically connected to the battery and coupled to one or more walls of the plurality of walls.

14. The tailgate drawer of claim 13, further comprising:
a power management unit electrically connected to the battery and the one or more electrical outlets and having an inverter, the power management unit being configured to provide a plurality of voltages to the one or more electrical outlets; and
wherein the battery is further configured to supply electrical energy to one or more electric motors of the vehicle.

15. The tailgate drawer of claim 11, further comprising:
one or more lights coupled to at least one wall of the plurality of walls and configured to illuminate the storage compartment when the drawer is in the first open position.

16. The tailgate drawer of claim 11, further comprising:
one or more doors moveably coupled to the bed floor and configured to move between a third closed position and a third open position; and
wherein:
the one or more doors are positioned along the first horizontal plane when the one or more doors are in the third closed position, and
the one or more doors enable access to the storage compartment when the one or more doors are in the third open position and the drawer is in the first closed position.

17. The tailgate drawer of claim 11, further comprising:
one or more actuators coupled to the drawer and configured to move the drawer between the first closed position and the first open position; and
an electronic control unit (ECU) electrically connected to the one or more actuators and configured to control the one or more actuators to move the drawer between the first closed position and the first open position.

18. The tailgate drawer of claim 17, further comprising:
one or more sensors electrically connected to the ECU and configured to detect a user waving a hand or a foot of the user near or underneath the drawer or the vehicle; and
wherein the ECU is further configured to:
receive an indication when the one or more sensors detect the user waving the hand or the foot of the user near or underneath the drawer or the vehicle, and
control the one or more actuators to move the drawer to the first open position in response to receiving the indication.

19. The tailgate drawer of claim 11, further comprising:
a lock configured to lock the drawer in the first closed position and unlock the drawer such that the drawer may move to the first open position; and
an electronic control unit (ECU) electrically connected to the lock and configured to control the lock to:
lock the drawer in response to receiving a lock signal from a key fob of the vehicle or a mobile device in communication with the ECU, and
unlock the drawer in response to receiving an unlock signal from the key fob of the vehicle or the mobile device.

20. The tailgate drawer of claim 11, further comprising:
one or more rails configured to movably couple the drawer to the vehicle; and
wherein the drawer is configured to be removable from the vehicle.
